(19) United States
(12) Patent Application Publication
(10) Pub. No.: US 2010/0153263 A1
(43) Pub. Date: Jun. 17, 2010

(54) CONDITIONAL COMPENSATION SYSTEM

(76) Inventors: Kevin Keadle, Seattle, WA (US); Chris Keadle, Seattle, WA (US)

Correspondence Address: Ruttler IP Law PLLC;One Union Square, 600 University Street, Suite 1919, Seattle, WA, 98101, US

(21) Appl. No.: 12/477,604

(22) Filed: Jun. 3, 2009

Related U.S. Application Data
(60) Provisional application No. 61/122,238, filed on Dec. 12, 2008.

(51) Int. Cl. G06Q 40/00

(52) U.S. Cl. 705/39

(57) ABSTRACT

This invention relates generally to software, and more specifically, to a conditional compensation system. In one embodiment, the invention includes an application server, the application server including a conditional compensation system, the conditional compensation system facilitating performance based compensation. In a further embodiment, the conditional compensation system includes an instrument component, the instrument component configured to establishing at least one instrument; an event management component, the event management component configured to adjusting the at least one instrument; and a payment component, the payment component configured to issuing at least one payment in accordance with the at least one instrument.

### PRIORITY CLAIM

This application claims the benefit of U.S. provisional patent application Ser. No. 61/122,238 filed Dec. 12, 2008 (our ref. KDLE-1-1001). The foregoing application is incorporated by reference in its entirety as if fully set forth herein.

### FIELD OF THE INVENTION

This invention relates generally to software, and more specifically, to a conditional compensation system.

### SUMMARY

This invention relates generally to software, and more specifically, to a conditional compensation system. In one embodiment, the invention includes an application server, the application server including a conditional compensation system, the conditional compensation system facilitating performance based compensation. In a further embodiment, the conditional compensation system includes an instrument component, the instrument component configured to establishing at least one instrument; an event management component, the event management component configured to adjusting the at least one instrument; and a payment component, the payment component configured to issuing at least one payment in accordance with the at least one instrument.

### BRIEF DESCRIPTION OF THE DRAWINGS

Embodiments of the present invention are described in detail below with reference to the following drawings:

FIG. 1 is a system diagram of an application server including a conditional compensation system, in accordance with an embodiment of the invention;

FIG. 2 is a flow diagram of a method performed by the conditional compensation system, in accordance with an embodiment of the invention;

FIG. 3 is a flow diagram of a method performed by the conditional compensation system, in accordance with an embodiment of the invention;

FIG. 4 is a flow diagram of a method performed by the conditional compensation system, in accordance with an embodiment of the invention; and

FIG. 5 is a flow diagram of a method performed by the conditional compensation system, in accordance with an embodiment of the invention.

### DETAILED DESCRIPTION

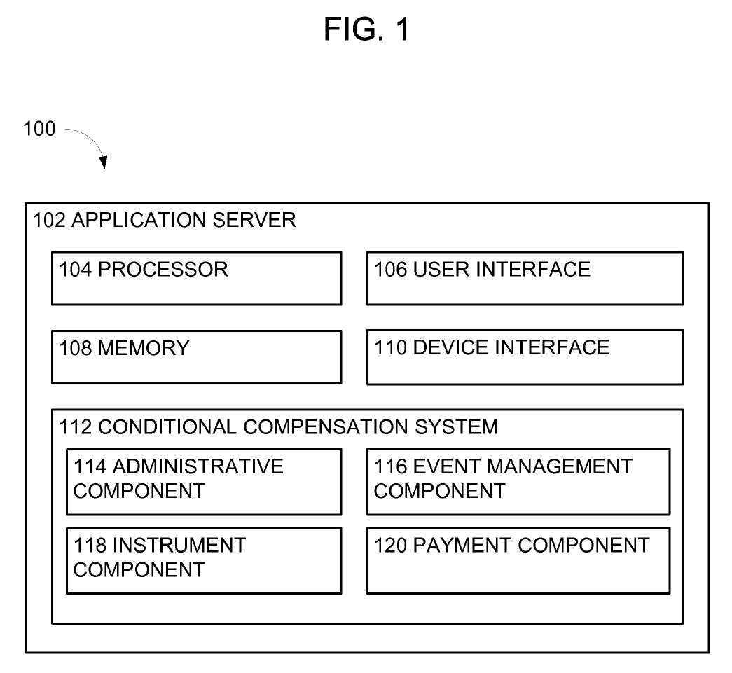

This invention relates generally to software, and more specifically, to a conditional compensation system. Specific details of certain embodiments of the invention are set forth in the following description and in FIGS. 1-5 to provide a thorough understanding of such embodiments. The present invention may have additional embodiments, may be practiced without one or more of the details described for any particular described embodiment, or may have any detail described for one particular embodiment practiced with any other detail described for another embodiment.

Many examples are provided herein to assist with understanding the invention; however, none of the examples are intended to be limiting as they are merely examples of the broader invention.

FIG. 1 is a system diagram of an application server including a conditional compensation system, in accordance with an embodiment of the invention. In one embodiment, system 100 includes an application server 102, the application server 102 including a processor 104, a user interface 106, a memory 108, a device interface 110, and a conditional compensation system 112. The conditional compensation system 112 includes an administrative component 114, an event management component 116, an instrument component 118, and a payment component 120. In some embodiments, the application server 102 can be any type of computer and can be accessible locally or remotely via electronic or wireless communications. In some embodiments, the application server 102 can be distributed among a plurality of computing devices. In some embodiments, the conditional compensation system 112 is a software application configured to operate on the application server 102. In some embodiments, the conditional compensation system 112 can be distributed among a plurality of computing devices. As will be described more fully herein, the conditional compensation system 112 is configured to facilitate performance based compensation, such as for mortgage originators, mortgage brokers, other loan originators, or any person who provides asset backed instruments, sales persons, employees, independent contractors, managers, executives, or other similar persons on behalf of one or more entities. For example, the conditional compensation system can be configured to facilitate performance based compensation for a mortgage broker on behalf of an investor or to facilitate performance based compensation for a loan originator on behalf of a mortgage broker. Many other alternatives are possible in any field of endeavor. In some embodiments, the instrument component 118 is configured to establish at least one instrument. In some embodiments, the event management component 116 is configured to adjust the at least one instrument. In some embodiments, the payment component 120 is configured to issue at least one payment in accordance with the at least one instrument. In some embodiments, the administrative component 114 is configured to manage the instrument component 118, the event management component 116, and the payment component 120. In some embodiments, the administrative component 114, the event management component 116, the instrument component 118, and the payment component 120 are combined or distributed into fewer or greater components. In some embodiments, the conditional compensation system 112 includes fewer or greater components.

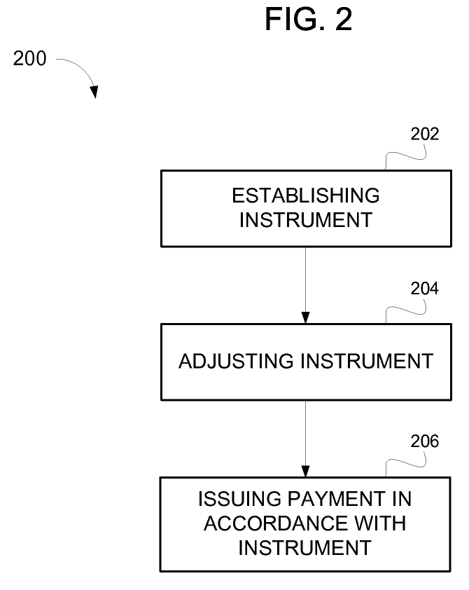

FIG. 2 is a flow diagram of a method performed by the conditional compensation system, in accordance with an embodiment of the invention. In one embodiment, method 200 is performed by the conditional compensation system 112. Method 200 includes establishing at least one instrument at 202, adjusting the at least one instrument at 204, and issuing payment in accordance with the at least one instrument at 206. As will be described more fully herein, an entity desiring to provide conditional compensation for another entity can access and use the conditional compensation system 112 to establish the conditional compensation based upon occurrence or non-occurrence of an event. For example, an investor desiring to provide conditional compensation to a mortgage broker or loan originator can access and use the conditional compensation system 112 to establish conditional compensation to the mortgage broker or loan originator that is tied to performance of a loan. Alternatively, a manager desiring to provide conditional compensation to an employee can access and use the conditional compensation system 112 to establish conditional compensation to the employee that is tied to customer satisfaction metrics. Similarly, a shareholder desiring to provide conditional compensation to an executive can access and use the conditional compensation system 112 to establish conditional compensation to the executive that is tied to a company stock price or future earnings. Also, a client desiring to provide conditional compensation to a stock broker can access and use the conditional compensation system 112 to establish conditional compensation to the stock broker that is tied to investment performance. Further, a home purchaser desiring to provide conditional compensation to a real estate agent can access and use the conditional compensation system 112 to establish conditional compensation to the real estate agent that is tied to future real estate values. The conditional compensation system 112 is therefore configured to provide any type of conditional compensation for any entity on behalf of any other entity for any event occurrence or non-occurrence. As such, the conditional compensation system 112 provides a flexible and functional framework to facilitate providing conditional compensation that is not limited to a particular industry, compensation, or event. Furthermore, the conditional compensation system 112 can supplement any existing conditional compensation system or can serve as an independent alternative for entities that would otherwise not have sufficient resources to build and maintain such a system. The conditional compensation system 112 can also provide for measures to prevent one entity from wrongfully terminating the conditional compensation or wrongfully accessing the conditional compensation, such as present in escrow services.

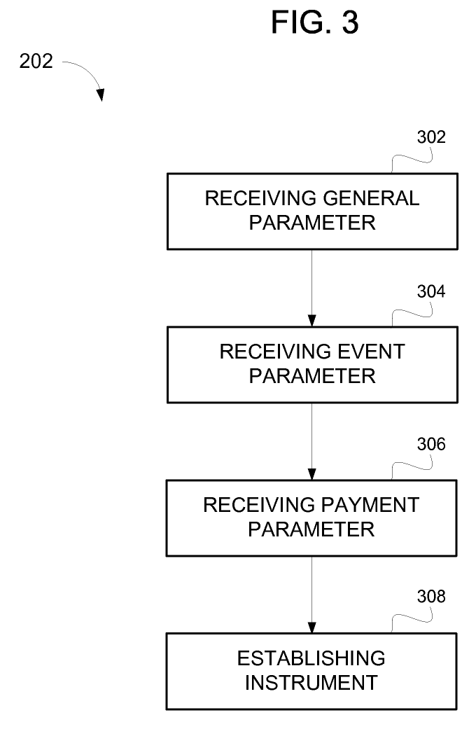

FIG. 3 is a flow diagram of a method performed by the conditional compensation system, in accordance with an embodiment of the invention. In one embodiment, method 202 is performed by the instrument component 118 of the conditional compensation system 112. Method 202 includes receiving at least one general parameter at 302; receiving at least one event parameter at 304; receiving at least one payment parameter at 306; and establishing the at least one instrument in accordance with the at least one general parameter, the at least one event parameter, and the at least one payment parameter at 308.

In some embodiments, the at least one general parameter comprises a principal amount of the at least one instrument. For example, the principal amount can be $10,000, $25,000, $100,000 or some other amount for the at least one instrument. In some embodiments, the principal amount of the at least one instrument is in a form of cash, stocks, or options. For example, the principal amount can be 100 shares of a company stock, 1,000 shares of a company stock, 10,000 shares of a company stock, 100,000 options to purchase a company stock at a particular strike price, or some other similar stock or option. Similarly, the principal amount can be in a form of shares in a mutual fund, an index fund, a money market account, or other interest such as in real estate, a jet, a yacht. Alternatively, the principal amount can be a personal object such as art, a vehicle, antique, a collectible, tickets, or other similar object. In some embodiments, the at least one general parameter comprises an investment vehicle for the at least one instrument. For example, the investment vehicle can be a savings account, a mutual fund account, an index fund, a stock, a bond, an option, or a money market account. In some embodiments, the investment vehicle for the at least one instrument is with an independent entity. Accordingly, the at least one general parameter can include a principal amount and an investment vehicle, such as $100,000 cash and a savings account with ING or a particular painting and a safety depository box with BANK OF AMERICA.

In some embodiments, the at least one event parameter comprises an event type. In some embodiments, the event type is customizable and in other embodiments the event type is non-customizable. In some embodiments, the event type is derived from a template that can be reused or manipulated. For example, in the case of an investor desiring to provide conditional compensation to a mortgage broker or loan originator, such as a lender, a government agency, an investment banking firm, an insurance company, or the like, the event type can be a loan payment default, a foreclosure, an early loan payoff, a pull through rate of locked to funded loans, a hedge cost related to a loan, or some other similar occurrence. In the case of a manager desiring to provide conditional compensation to an employee, the event type can be customer survey result, a product launch date, a number of missed employment days, or some other similar occurrence. In the case of a shareholder desiring to provide conditional compensation to an executive, the event type can be a stock price, a future revenue amount, a future expense amount, a future profit, a future cash flow amount, a product launch date, or some other similar occurrence. In the case of a client desiring to provide conditional compensation to a stock broker, the event type can be performance of an investment, performance of an investment relative to an index, a tax savings, or some other similar circumstance. In the case of a home purchaser desiring to provide conditional compensation to a real estate agent, the event type can be existence of a defect, a future house value price, a future neighborhood average real estate price, an incidence of crime, a school ranking, or some other similar circumstance.

In some embodiments, the event type is associated with at least one consequence for the at least one instrument. In some embodiments, the at least one consequence comprises adjusting a principal amount, a payment amount, a payment frequency, or a payee of the at least one instrument, which are further described supra. In some embodiments, the consequence is customizable and in other embodiments the consequence is non-customizable. In some embodiments, the consequence is negative and in other embodiments the consequence is positive. In some embodiments, a plurality of consequences are associated with the event type and in some embodiments a plurality of event types are each associated with at least one consequence. In some embodiments, the at least one consequence is derived from a template that can be reused or manipulated. In some embodiments, the at least consequence varies depending upon the number or type of previously incurred consequences. For example, in the case of an investor desiring to provide conditional compensation to a mortgage broker or loan originator, a loan payment default can be associated with a consequence of reducing a principal amount, adjusting a payment amount, and reimbursing the investor by the amount reduced. In the case of an investor desiring to provide conditional compensation to a mortgage broker or loan originator, a foreclosure can be associated with a consequence of forfeiting a principal amount and reimbursing the investor by the amount forfeited. In the case of an investor desiring to provide conditional compensation to a mortgage broker or loan originator, a favorable pull through rate can be associated with a consequence of increasing a principal amount, a payment amount, or a payment frequency. In the case of a manager desiring to provide conditional compensation to an employee, meeting a product launch date can be associated with a consequence of complete and immediate payout of a principal amount. In the case of a shareholder desiring to provide conditional compensation to an executive, a low future revenue amount can be associated with a consequence of indefinite deferment of a payment amount until the future revenue amount is reached. In the case of a client desiring to provide conditional compensation to a stock broker, favorable performance of an investment relative to an index can be associated with a consequence of beginning a payment frequency. In the case of a home purchaser desiring to provide conditional compensation to a real estate agent, a favorable future neighborhood average real estate price can be associated with a consequence of adjustment of a payment amount as a function of the average real estate price.

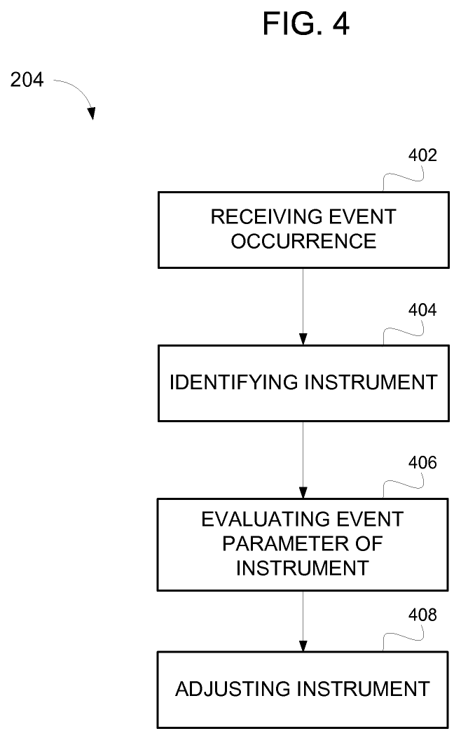

In some embodiments, the at least one payment parameter comprises a payment amount, a payment frequency, and at least one payee. For example, the payment amount can be a percentage of a principal amount of the at least one instrument, a fixed amount, a variable amount, an escalating amount, or some other similar amount. The payment frequency can be daily, weekly, monthly, annually, or some other regular or irregular period. The at least one payee can be a person, a plurality of persons, a group, an organization, a company, or some other entity and can include two or more payees. Accordingly, the at least one payment parameter can be a percentage of a principal amount every year to a mortgage broker or loan originator. Alternatively, the at least one payment parameter can be a fixed number of stock options with a particular strike price payable a single time to an executive. Also, an at least one payment parameter can be a fixed amount payable a single time to a plurality of employees. As will be discussed further infra, the at least one payment parameter can be subject to adjustment by the event management component (FIG. 4).

In some embodiments, the instrument component 118 is configured to establishing the at least one instrument by facilitating initial funding for the at least one instrument. For example, the instrument component 118 can facilitate a debit card charge, a credit card charge, a wire transfer, a bank account withdrawal, an interest recording, or an object acquisition to support a principal amount of the at least one instrument.

In some embodiments, the instrument component is configured to establishing the at least one instrument in accordance with the at least one general parameter, the at least one event parameter, and the at least one payment parameter at 308. For example, in the case of an investor desiring to provide conditional compensation to a mortgage broker or loan originator, the at least one instrument can include a principal amount of $10,000 within a money market investment vehicle having a payment amount of 1/30^{th} of the principal amount annually to the mortgage broker or loan originator. The at least one instrument can further include event types of a loan payment default, a foreclosure, an early loan payoff, a pull through rate of locked to funded loans, a hedge cost related to a loan, or any other event that has an impact on the performance or value of an underlying asset or loan. The loan payment default, the pull through rate, and the hedge cost can be associated with a consequence of a reduced principal amount and the foreclosure and early loan payoff can be associated with forfeiture of the principal amount, both with reimbursements directed to the investor. In the case of a manager desiring to provide conditional compensation to an employee, the at least one instrument can include a principal amount of 5,000 shares of company stock having a payment amount of 100 shares biannually to the employee. The at least one instrument can further include an event type of a number of missed employment days, which can be associated with a consequence of reducing the principal amount by a fixed number of shares for a certain number of missed employment days with reimbursements directed to the employer. In the case of a shareholder desiring to provide conditional compensation to an executive, the at least one instrument can include a principal amount of 100,000 stock options in company stock at a strike price of $10 having a payment amount of all 100,000 options to the executive upon meeting company stock price requirements. The at least one instrument can further include an event type of a company stock price, which can be associated with a consequence of distributing the principal amount immediately upon reaching a particular company stock price. The foregoing are just a few example as an unlimited number of instruments can be established in accordance with method 202, each with differing principal amounts, investment vehicles, event types, consequences, payment amounts, payment frequencies, and payees.

FIG. 4 is a flow diagram of a method performed by the conditional compensation system, in accordance with an embodiment of the invention. In one embodiment, method 204 is performed by the event management component 116 of the conditional compensation system 112. Method 204 includes receiving at least one event occurrence at 402, identifying at least one instrument at 404, evaluating at least one event parameter of the at least one instrument at 406, and adjusting the at least one instrument at 408. Method 204 can be performed for a single event occurrence for a single instrument, a plurality of event occurrences for a single instrument, a single event occurrence for a plurality of instruments, or a plurality of event occurrences for a plurality of instruments.

In some embodiments, the at least one event occurrence is received manually or automatically. For example, the at least one event occurrence can be received automatically electronically or wirelessly using a periodic monitoring system of one or more data sources. Alternatively, the at least one event occurrence can be received manually electronically, wirelessly, or audibly using a user interface supporting data input or selection.

In some embodiments, the at least one event occurrence comprises or is translatable into an event type. For example, the event type can include a loan payment default, a foreclosure, an early loan payoff, a pull through rate of locked to funded loans, a hedge cost related to a loan, a customer survey result, a product launch date, a number of missed employment days, a stock price, a revenue amount, an expense amount, a profit, a cash flow amount, a product launch date, performance of an investment, performance of an investment relative to an index, a tax savings, existence of a defect, a house value price, a neighborhood average real estate price, an incidence of crime, a school ranking, or any other similar circumstance.

In some embodiments, the at least one instrument is identified by the event type. The received event type can correspond to an event type of an established instrument (FIG. 3) and can therefore be used to identify the at least one instrument. For example, a received event type of a loan payment default, a foreclosure, an early loan payoff, a pull through rate of locked to funded loans, or a hedge cost related to a loan can be used to identify an instrument for providing conditional compensation to a mortgage broker or loan originator that has an event parameter including a corresponding event type. Similarly, a received event type of a customer survey result, a product launch date, or a number of missed employment days can be used to identify an instrument for providing conditional compensation to an employee that has an event parameter including a corresponding event type. Also, a received event type of a stock price, a revenue amount, an expense amount, a profit, a cash flow amount, or a product launch date can be used to identify an instrument for providing conditional compensation to an executive that has an event parameter including a corresponding event type. Furthermore, a received event type of performance of an investment, performance of an investment relative to an index, or a tax savings can be used to identify an instrument for providing conditional compensation to a stock broker that has an event parameter including a corresponding event type. Additionally, a received event type of existence of a defect, a house value price, a future neighborhood average real estate price, an incidence of crime, or a school ranking can be used to identify an instrument for providing conditional compensation to a real estate agent that has an event parameter including a corresponding event type. In some embodiments, the at least one instrument is identified by user selection received electronically, wirelessly, or audibly.

In some embodiments, the at least one instrument is evaluated by determining at least one consequence for the event type. For example, in the case of an instrument for providing conditional compensation to a mortgage broker or loan originator, a consequence of reducing a principal amount, adjusting a payment amount, and reimbursing an investor by the amount reduced can be determined for an event type of a loan payment default. Similarly, in the case of an instrument for providing conditional compensation to a mortgage broker or loan originator, a consequence of forfeiting a principal amount and reimbursing an investor by the amount forfeited can be determined for an event type of a foreclosure. Also, in the case of an instrument for providing conditional compensation to a mortgage broker or loan originator, a consequence of increasing a payment amount or a payment frequency can be determined for an event type of a pull through rate. Further, in the case of an instrument for providing conditional compensation to an employee, a consequence of complete and immediate payout of a principal amount can be determined for an event type of a product launch date. Also, in the case of an instrument for providing conditional compensation to an executive, a consequence of indefinite deferment of a payment amount until the revenue amount is reached can be determined for an event type of a revenue amount. Additionally, in the case of an instrument for providing conditional compensation to a stock broker, a consequence of beginning a payment frequency can be determined for an event type of performance of an investment relative to an index. Similarly, in the case of an instrument for providing conditional compensation to a real estate agent, a consequence of adjustment of a payment amount as a function of an average real estate price can be determined for an event type of a neighborhood average real estate price. In some embodiments, the at least one consequence is determined based upon a value of the event type. For example, the at least one consequence can vary depending upon a value of the pull through rate, a revenue amount, a performance of an investment, or an average real estate price.

In some embodiments, the at least one instrument is adjusted in accordance with the determined at least one consequence. In some embodiments, the adjustment includes adjusting a principal amount, a payment amount, a payment frequency, or a payee of the at least one instrument. For example, in the case of an instrument for providing conditional compensation to a mortgage broker or loan originator, a principal amount and a payment amount can be reduced and an investor can be scheduled for reimbursement for an event type of a loan payment default. Similarly, in the case of an instrument for providing conditional compensation to a mortgage broker or loan originator, a principal amount can be forfeited and an investor can be scheduled for reimbursement by the amount forfeited for an event type of a foreclosure. Also, in the case of an instrument for providing conditional compensation to a mortgage broker or loan originator, a payment amount or payment frequency can be increased for an event type of a pull through rate based upon a value of the pull through rate. Further, in the case of an instrument for providing conditional compensation to an employee, a payout of a principal amount can be scheduled for an event type of meeting a product launch date. Also, in the case of an instrument for providing conditional compensation to an executive, a deferment of a payment amount can be made for an event type of a revenue amount based upon a value of the revenue amount. Additionally, in the case of an instrument for providing conditional compensation to a stock broker, a payment frequency can be scheduled to begin for an event type of performance of an investment relative to an index based upon a value of the performance. Similarly, in the case of an instrument for providing conditional compensation to a real estate agent, a payment amount can be adjusted as a function of an average real estate price for an event type of a neighborhood average real estate price based upon a value of the neighborhood average real estate price.

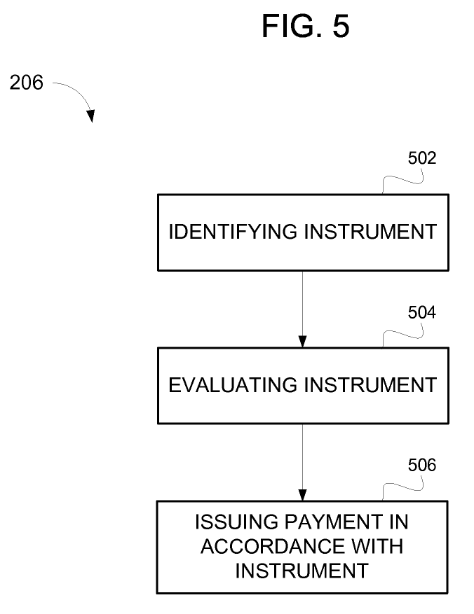

FIG. 5 is a flow diagram of a method performed by the conditional compensation system, in accordance with an embodiment of the invention. In one embodiment, method 206 is performed by the payment component 120 of the conditional compensation system 112. Method 206 includes identifying at least one instrument at 502, evaluating the at least one instrument at 504, and issuing payment in accordance with the at least one instrument at 506. Method 206 can be performed with regards to a single instrument or a plurality of instruments.

In some embodiments, at least one instrument is identified by user selection received electronically, wirelessly, or audibly. For example, user selection can be received for an instrument for providing conditional compensation to a mortgage broker or loan originator, an instrument for providing conditional compensation to an employee, an instrument for providing conditional compensation to an executive, an instrument for providing conditional compensation to a stock broker, or an instrument for providing conditional compensation to a real estate agent. In some embodiments, the user selection can be received for a single instrument or for a plurality of instruments. In some embodiments, the user selection can be received via an electronic user interface, such as a website or client application. In some embodiments, the user selection can be received via voice communication, such as via a phone or personal digital assistant.

In some embodiments, the at least one instrument is identified automatically in accordance with a payment frequency of the at least one instrument. For example, an instrument for providing conditional compensation to mortgage broker or loan originator can be automatically identified in accordance with an annuity payment being due within a week. Similarly, an instrument for providing conditional compensation to an employee can be automatically identified in accordance with a bonus payment being past due. Also, an instrument for providing conditional compensation to an executive can be identified in accordance with a stock option distribution being due within 5 years. Further, an instrument for providing conditional compensation to a stock broker can be identified in accordance with a client reimbursement being due. Additionally, an instrument for providing conditional compensation to a real estate agent can be identified in accordance with an annuity payment being due within a month. In some embodiments, a plurality of instruments can be identified automatically in accordance with a payment frequency of the instruments. In some embodiments, the at least one instrument can be identified automatically using another parameter, such as an event type, a consequence, a history, or some other similar parameter. In some embodiments, parameters for automatically identifying a plurality of instruments can be defined via a user interface, such as through a website, voice communication, or client application.

In some embodiments, the at least one instrument is evaluated by determining a payment amount, a payment frequency, or at least one payee of the at least one instrument. The payment amount, the payment frequency, and the at least one payee can reflect any adjustments performed in accordance with the event management component 116 as a result of any event occurrences (FIG. 4). For example, the payment amount can be a percentage of a principal amount of the at least one instrument, a fixed amount, a variable amount, or an escalating amount, which payment amount can be subject to being reduced, increased, or modified due to the occurrence of an event. The payment frequency can be daily, weekly, monthly, annually, or some other regular or irregular period, which payment frequency can be subject to being reduced, increased, or modified due to the occurrence of an event. The at least one payee can be a person, a plurality of persons, a group, an organization, a company, or some other entity, which payee can be subject to being changed or modified, such as to include a different payee, fewer payees, or more payees, due to the occurrence of an event. For example, in the case of an instrument for providing conditional compensation to a mortgage broker or loan originator, the payment amount can be 10% of a principal amount of $10,000 every year to the mortgage broker or loan originator subject to any adjustments by the event management component 116. Similarly, in the case of an instrument for providing conditional compensation to an employee, the payment amount can be $5,000 a single time to the employee subject to any adjustments by the event management component 116. Also, in the case of an instrument for providing conditional compensation to an executive, the payment amount can be 1,000 stock options with a strike price of $10 a single time to the executive subject to any adjustments by the event management component 116. Further, in the case of an instrument for providing conditional compensation to a stock broker, the payment amount can be $500 for every $10,000 in capital gains earned for a client to the stock broker subject to any adjustments by the event management component 116. Additionally, in the case of an instrument for providing conditional compensation to a real estate agent, the payment amount can be 1/30 of a principal amount of $10,000 every year to the real estate agent subject to any adjustments by the event management component 116.

In some embodiments, the payment is issued to the at least one payee for the payment amount on schedule with the payment frequency. The issued payment reflects any adjustments performed in accordance with the event management component 116 as a result of any event occurrences (FIG. 4). The payment can be issued on demand or automatically and independently or as part of a batch. The payment can be issued via check, direct deposit, wire transfer, physical delivery, mail, or some other similar methodology. For example, in the case of an instrument for providing conditional compensation to mortgage broker or loan originator, a payment can be directly deposited in an account of the mortgage broker or loan originator every first of January. Similarly, in the case of an instrument for providing conditional compensation to an employee, the bonus payment amount can be mailed as a check to the employee upon meeting a product launch date. Also, in the case of an instrument for providing conditional compensation to an executive, the stock options can be mailed to the executive upon meeting revenue requirements. Further, in the case of an instrument for providing conditional compensation to a stock broker, the payment amount can be wire transferred to the stock broker upon meeting capital gains requirements. Additionally, in the case of an instrument for providing conditional compensation to a real estate agent, the payment amount can be directly deposited into an account of the real estate agent every 15^{th} of June. In some embodiments, the payment can be split and issued to two or more payees. In some embodiments, the instrument is updated to reflect that the payment was issued, such as by reducing a principal amount or providing a record of the transaction.

In some embodiments, the administrative component 114 of the conditional compensation system 112 is configured to facilitate managing user access to the conditional compensation system; managing the instrument component 118; managing the event management component 116; managing the payment component 120; managing instruments such as with general parameters, event parameters, payment parameters; managing event occurrences; managing instrument adjustments; managing payment issuance; managing templates; managing principal amounts supporting instruments; managing groups of instruments; reporting; and generally attending to any feature disclosed or referenced herein. The administrative component 114 can be accessed electronically, wirelessly, or audibly via local or remote communication.

While preferred and alternate embodiments of the invention have been illustrated and described, as noted above, many changes can be made without departing from the spirit and scope of the invention. Accordingly, the scope of the invention is not limited by the disclosure of these preferred and alternate embodiments. Instead, the invention should be determined entirely by reference to the claims that follow.

What is claimed is:

1. An application server, the application server comprising:
a conditional compensation system, the conditional compensation system facilitating performance based compensation.

2. The application server of claim 1, wherein the conditional compensation system comprises:
an instrument component, the instrument component configured to establishing at least one instrument;
an event management component, the event management component configured to adjusting the at least one instrument; and
a payment component, the payment component configured to issuing at least one payment in accordance with the at least one instrument.

3. The application server of claim 2, wherein the instrument component is configured to establishing at least one instrument by the steps comprising:
receiving at least one general parameter;
receiving at least one event parameter;
receiving at least one payment parameter; and
establishing the at least one instrument in accordance with the at least one general parameter, the at least one event parameter, and the at least one payment parameter.

4. The application server of claim 3, wherein the at least one general parameter comprises a principal amount of the at least one instrument.

5. The application server of claim 4, wherein the principal amount of the at least one instrument is in a form of cash, stocks, or options.

6. The application server of claim 5, wherein the at least one general parameter comprises an investment vehicle for the at least one instrument.

7. The application server of claim 3, wherein the at least one event parameter comprises an event type.

8. The application server of claim 7, wherein the event type is associated with at least one consequence for the at least one instrument.

9. The application server of claim 8, wherein the event type comprises a loan payment default, a foreclosure, an early loan payoff, a pull through rate, or a hedge cost.

10. The application server of claim 8, wherein the at least one consequence comprises adjusting a principal amount, a payment amount, a payment frequency, or a payee of the at least one instrument.

11. The application server of claim 8, wherein the event type and the at least one consequence are derived from a template.

12. The application server of claim 3, wherein the at least one payment parameter comprises a payment amount, a payment frequency, and at least one payee.

13. The application server of claim 3, wherein the instrument component is configured to establishing at least one instrument by the steps comprising:
facilitating initial funding for the at least one instrument.

14. The application server of claim 3, wherein the event management component is configured to adjusting the at least one instrument by the steps comprising:
receiving at least one event occurrence;
identifying the at least one instrument;
evaluating the at least one event parameter of the at least one instrument; and
adjusting the at least one instrument.

15. The application server of claim 14, wherein the at least one event occurrence is received manually or automatically.

16. The application server of claim 15, wherein the at least one event occurrence comprises an event type.

17. The application server of claim 16, wherein the event type is a loan payment default, a foreclosure, an early loan payoff, a pull through rate, or a hedge cost.

18. The application server of claim 16, wherein the at least one instrument is identified by the event type.

19. The application server of claim 18, wherein the at least one event parameter of the at least one instrument is evaluated by determining at least one consequence for the event type.

20. The application server of claim 19, wherein the at least one consequence comprises adjusting a principal amount, a payment amount, a payment frequency, or a payee of the at least one instrument.

21. The application server of claim 20, wherein the adjusting the at least one instrument comprises adjusting the principal amount, the payment amount, the payment frequency, or the payee of the at least one instrument in accordance with the at least one consequence.

22. The application server of claim 21, wherein the adjusting the at least one instrument comprises scheduling payment to at least one payee in an amount determined by the adjustment.

23. The application server of claim 3, wherein the payment component is configured to issuing at least one payment in accordance with the at least one instrument by the steps comprising:
identifying the at least one instrument;
evaluating the at least one instrument; and
issuing payment in accordance with the at least one instrument.

24. The application server of claim 23, wherein the at least one instrument is identified by received user selection.

25. The application server of claim 23, wherein the at least one instrument is identified automatically in accordance with a payment frequency of the at least one payment parameter.

26. The application server of claim 23, wherein the at least one instrument is evaluated by determining a payment amount, a payment frequency, or at least one payee of the at least one instrument.

27. The application server of claim 26, wherein the payment amount, the payment frequency, and the at least one payee include any adjustments performed by the event management component as a result of any event occurrences.

28. The application server of claim 27, wherein the payment is issued to the at least one payee for the payment amount on schedule with the payment frequency.

29. The application server of claim 28, wherein the payment is split and issued to two or more payees.

30. The application server of claim 27, wherein the payment component is configured to issuing at least one payment in accordance with the at least one instrument by the steps comprising:
updating the at least one instrument to reflect the payment issued.
